(19) United States
(12) Patent Application Publication
(10) Pub. No.: US 2009/0132369 A1
(43) Pub. Date: May 21, 2009

(54) PORTABLE RECHARGEABLE MULTIMEDIA DEVICE (PROTEAN)

(76) Inventor: Marco Scibora, St. Paul, MN (US)

Correspondence Address: BRIGGS AND MORGAN P.A., 2200 IDS CENTER, 80 SOUTH 8TH ST, MINNEAPOLIS, MN, 55402, US

(21) Appl. No.: 12/272,368

(22) Filed: Nov. 17, 2008

Related U.S. Application Data
(60) Provisional application No. 60/988,467, filed on Nov. 16, 2007.

(51) Int. Cl. G06Q 30/00; G06Q 90/00

(52) U.S. Cl. 705/14

(57) ABSTRACT

A digital signage system and method for centralized management of digital media content with distributed display of the digital media content. The system includes a centralized data processing system having a database containing digital media content, the digital media content implementing a retail promotion having a specific start date, a specific end date, and identities of a number of distributed particular machines implementing the retail promotion; and a first network connection; a number of particular machines implementing the distributed display of the digital media content, each particular machine having a central processing unit, a display, and a memory storing the identity of the particular machine; a program executing in the memory; and a second network connection. Each of the particular machines intermittently connects to the centralized data processing system through the first connection and the second connection, and the centralized data processing system receives the identity of the particular machine and downloads the digital media content to that identified particular machine. The program executing in the memory of each of the plurality of particular machines transforms the downloaded digital media content into a two-dimensional field on the display representative of the retail promotion.

### CROSS-REFERENCE TO RELATED APPLICATION

The present application is based on and claims the benefit of U.S. provisional patent application Ser. No. 60/988,467, filed Nov. 16, 2007, the content of which is hereby incorporated by reference in its entirety.

### BACKGROUND OF THE INVENTION

The present invention relates to an apparatus implementing a digital audio/video technology allowing unfettered placement of digital sign displays anywhere in a physical retail space.

There is a need for a digital sign technology that does not require cable or wireless connectivity or AC power to operate.

### SUMMARY OF THE INVENTION

The present invention is an apparatus implementing a digital audio/video technology allowing unfettered placement of digital sign displays anywhere in a physical retail space. The present invention is able to operate independently of any in-store LAN infrastructure or AC power availability. The present invention is capable of disseminating high quality digital media content in a linear fashion (loop video or graphics) and/or information requested by the shopper through a touch screen interactive video interface.

A benefit of the present invention is the “process” by which the retailer can easily control the placement of the Display(s) on the retail floor space and manage the update process for the desired content to be used on an as needed basis. It is designed to accommodate frequent and on-demand in-store promotional events throughout the store. It is by design a manual process requiring the store employee to bring either the AC-Powered Sign to the Docking Station or bring the DC-Powered Sign to the tether station for content change out after the original promotion expires.

The present invention relates to a digital audio/video technology allowing unfettered placement of Digital Sign(s) 100 (DS) anywhere within physical retail space. This technology DOES NOT requires cabled or wireless connectivity, or when applicable, AC power to operate. It is able to operate independently of any in-store LAN infrastructure or AC power availability. This technology is capable of disseminating high quality of digital media content in a linear fashion (loop video or graphics) and/or information requested by the shopper through a touch screen interactive user interface.
The hardware of the present invention is comprised of two basic elements:

1) Digital Signs there are two types of Portable Digital Signs available:

(i) AC-Powered Digital Sign (wired or wireless)—This is a self-contained thin Digital Sign which requires an AC power when used on the retail Floor. This Digital Sign is equipped with the following:
Video screen size ranging from 4″ to 42″ (other sizes are available)
Touch Screen, motion detector and/or bar-code or magnetic card reader
Each Digital Signage Display has its own unique name (ID)
VESA Mounting
motion detector

Software:
User interface (interactive
Custom regionalize display
Network control
Self Auto-Identify program
Statistics
motion detector controller

(ii) DC-Powered Digital Sign—DC-Powered Digital Sign incorporates the above described Portable Display with added integrated All-In-One wheel-locking caddy equipped with DC-PowerPak. This integrated fixture encompasses a height adjustable Display post and four-sided horizontal tracks for placement of custom printed material. The caddy (12″W×8″D×10″H) is also outfitted with 170 Hrs. PowerPak with built in charger and LED display power meter. A motion detector provides tight power management control. When no motion is detected within a specified distance and within specified amounts of time, the display light will go off to save battery power. Once any motion is detected, the display will turn itself on immediately.

2) Docking Stations (DOS):

The Docking Station(s) is an integral part of the Protean system designed to be placed in the designated area of the store equipped with AC power and wired or wireless Local Area Network (LAN) connection. A single or multi-port Docking Station(s) is outfitted with an appropriate number of Wide Area Network (WAN) ports and a single AC Power receptacle. The sole purpose of the Docking Station(s) is for hands free “changing out” the digital content. Each Docking Station(s) can be configured to service a single or multiple Sign(s). A single Docking Station is designed to accommodate both AC-Powered and DC-Powered Digital Signs. Each Docking Station is equipped with six independent tracks for vertical docking of each AC-Powered Sign as well as six independent cabled connectors for DC-Powered Signs. This configuration is designed to facilitate hands-free content change out for AC & DC-Powered Signs with the additional function of charging the PowerPak of the DC-Powered Sign. Each Docking Station can be configured to service a single or multiple Digital Sign by way of tethered AC power, LAN, and WAN within a single connector(s).

A benefit of the present invention is the “process” by which the retailer can easily control the placement of the Display(s) on the retail floor space and manage the update process for the desired content to be used on an as needed basis. It is designed to accommodate frequent and on-demand in-store promotional events throughout the store. It is by design a manual process requiring the store employee to bring either the AC-Powered Sign to the Docking Station or bring the DC-Powered Sign to the tether station for content change out after the original promotion expires.

### Digital Content Management/Update

Each Digital Sign is equipped with software to manage a clock and screen display to be ON or OFF. When docked or tethered each Sign is positioned vertically. As such, each screen of the Sign will be clearly visible to all store employees moving about. The main concept of this service is to preload each Sign with digital content coordinated with scheduled store promotion in the specific department for specific product(s) or service. A participating retailer will work with a services provider (RDCS) to provide proper information related to a desired number of promotional events; identify the store's department, products/services, participating manufacturer(s), and the scope of the promotion, digital content, the beginning and duration of the event with a clear description of placement of the device. With that information, the services provider will take on the responsibility of procuring or creating device-specific content for the desired promotional event. Once the promotional presentation is completed, it will be ready for distribution to each participating retail outlet. A Sign which is not scheduled for an event will have its screen turned off (remotely controlled by RDCS). After the event related content is uploaded to each designated Sign, its screen will be turned ON. Along with new content, RDCS will send time-sensitive visual scheduled/slotted for that specific Sign. At a scheduled time, for example, twenty four hours prior to the scheduled placement of each Sign the screen may preferably display a large static message in which department the unit needs to placed, date and time of the promotion and product or services to be promoted, etc. At another scheduled time, for example, twelve hours prior to the placement of the devices, the same template message will preferably become more animated. If the Sign has NOT been removed (from WAN) and placed as scheduled, the message on the display will preferably take on the “URGENT” nature with flashing messages designed to trigger greater attention to the store personnel.

Once the Sign is disconnected from WAN/Power, RDCS will register the disconnect. Also, once the Sign is placed in the designated location of the store and turned on, a clock will monitor the start and an end of total running time. In addition, the Sign will monitor its operation by keeping track of every A/V presentation during the scheduled period, as well as shopper selections of all interactive functions if an interactive application is allowed for the specific promotion.

At the end of the scheduled promotional event, the Sign will preferably automatically purge itself from all original promotional event material and revert to a generic message specific to this department, intermixed with a periodic reminder to remove the device. If the Sign is still NOT removed from its originally designated location (not reconnected to WAN) in 24 hours, a static message will preferably indicate prompt removal of the device.

When units are returned to the Docking Station they need to be docked or tethered appropriately. Once the Sign is connected back to the WAN, (by a wired or wireless connection) RDCS will detect the unit(s) and confirm that it is properly powered, retrieve all operating statistics and turn off the screen.

When a new program is scheduled for another promotion the above is repeated.

### BRIEF DESCRIPTION OF DRAWINGS

FIG. 1 is a block diagram showing the environment of the present invention.

FIG. 2 is a block diagram showing the connection of several digital signs to a multi-port docking station, all of the above of the present invention.

FIG. 3 is a schematic of the connections of a digital sign of the present invention to a docking station of the present invention.

FIG. 4 is a schematic of the digital sign of the present invention.

FIGS. 4a and 5 are flowcharts of the software of the present invention.

FIG. 6 is a schematic of the display of the digital sign of the present invention.

### DETAILED DESCRIPTION OF PREFERRED EMBODIMENTS

In a first aspect, the present invention comprises: a digital signage system for centralized management of digital media content with distributed display of the digital media content, comprising: a centralized data processing system 10 further comprising: a database 12 containing digital media content 18, the digital media content implementing a retail promotion having a specific start date, a specific end date, and identities 16 of a plurality of distributed particular machines implementing the retail promotion; and a first network connection 14;

a plurality of particular machines 100 implementing the distributed display of the digital media content, each particular machine further comprising: a central processing unit 210, a display 150, and a memory 230 storing the identity of the particular machine; a program executing in the memory 230; and a second network connection 130;

wherein each of the plurality of particular machines 100 intermittently connects to the centralized data processing system 10 through the first network connection 14 and the second network connection 130, the centralized data processing system 10 receiving the identity 16 of the particular machine 100 and downloading the digital media content 18 to that identified particular machine;

wherein the program executing in the memory 230 of each of the plurality of particular machines 100 transforms the downloaded digital media content 18 into a two-dimensional field on the display 150 representative of the retail promotion.

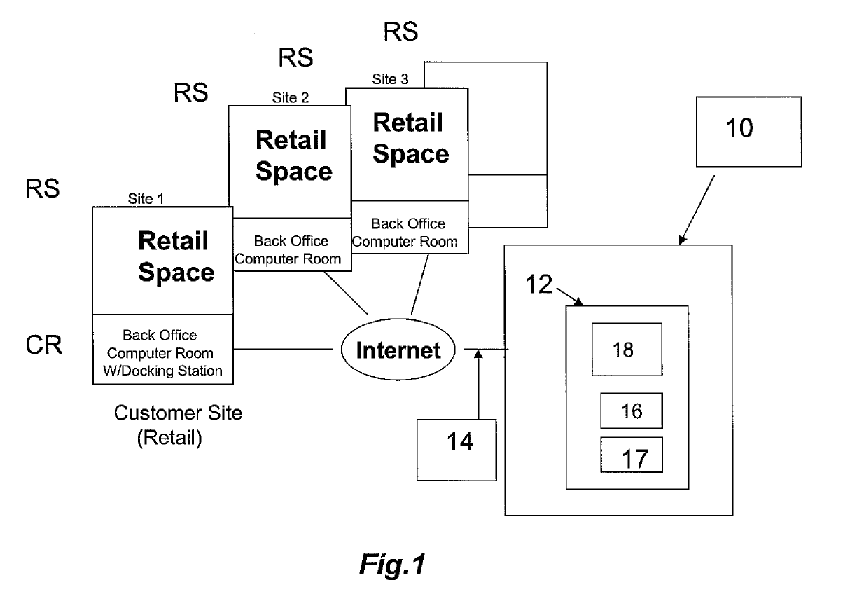

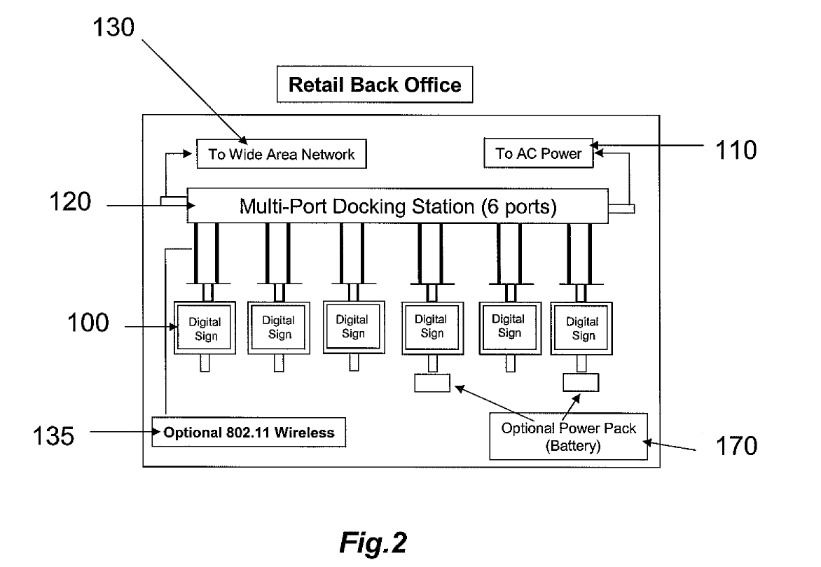

FIG. 1 illustrates the environment of the present invention. One or more retail spaces RS are connected, suitably by the Internet, to a Remote Data Control Services (RDCS) (centralized data processing system 10). Each of the retail spaces RS may have a back office computer room CR or other location with docking stations DOS 120 (shown in FIG. 2).

FIG. 2 shows the connection of one or more digital signs 100 (particular machines) to a multi-port docking station 120 in the CR or other location.

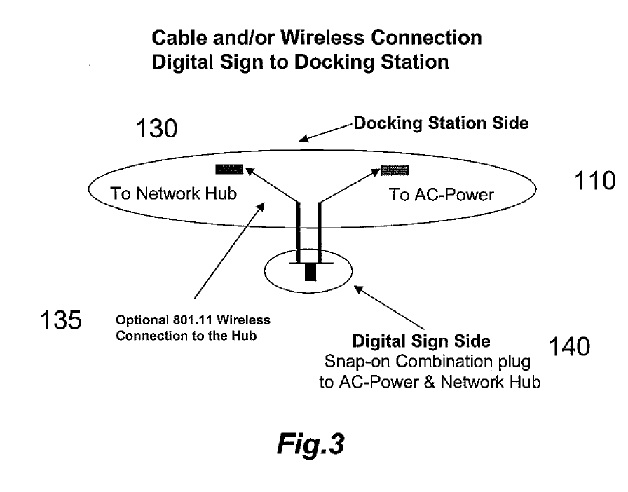

FIGS. 2 and 3 schematically illustrate the connections of the digital sign 100 of the present invention to a docking station 300. The digital sign 100 may comprise an AC power connection 110, and a connection 130 to a network hub, such as for example an 801.11 wireless connection 135. The AC power connection and the connection to the network hub may, in one embodiment, be combined into a combination plug 140.

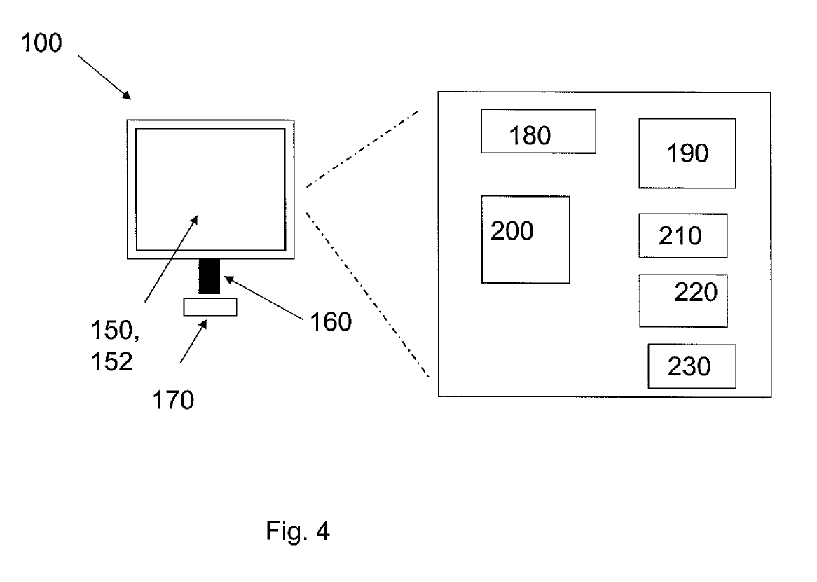

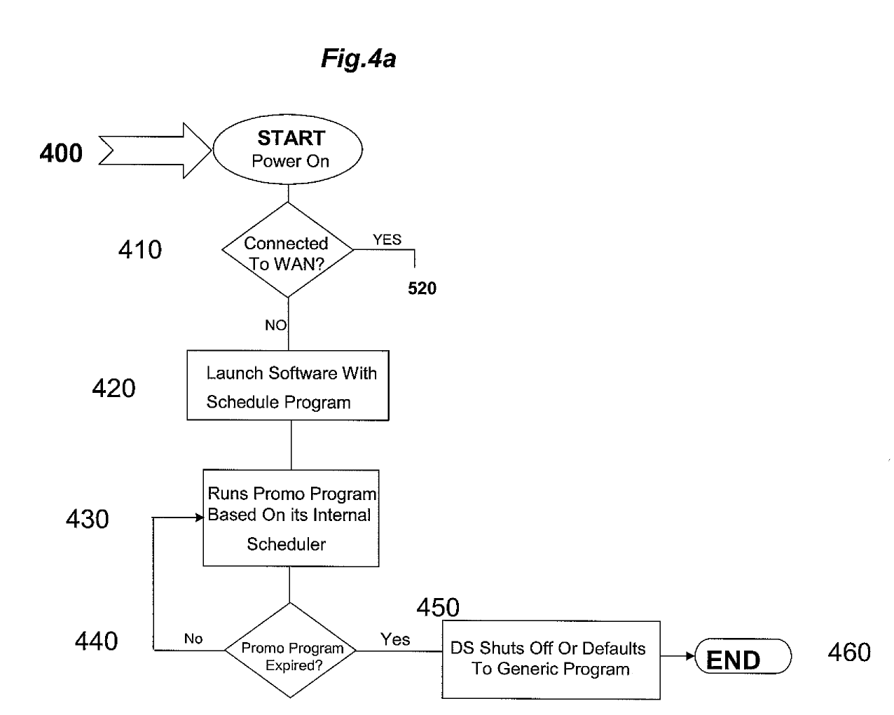

FIG. 4 illustrates the components of a digital sign 100 of the present invention. The digital sign 100 may preferably comprise a display 150, which may be a touch screen 152, a mount 160, and (if the digital sign is DC powered) a battery pack 170. The digital sign 100 may, in some embodiments, further comprise speakers 180, a barcode scanner 190, a motion detector 200, and appropriate processing hardware such as a central processing unit 210, a digital signal processor 220, and internal storage 230. Operating software, to be described below, executes on the central processing unit 210.

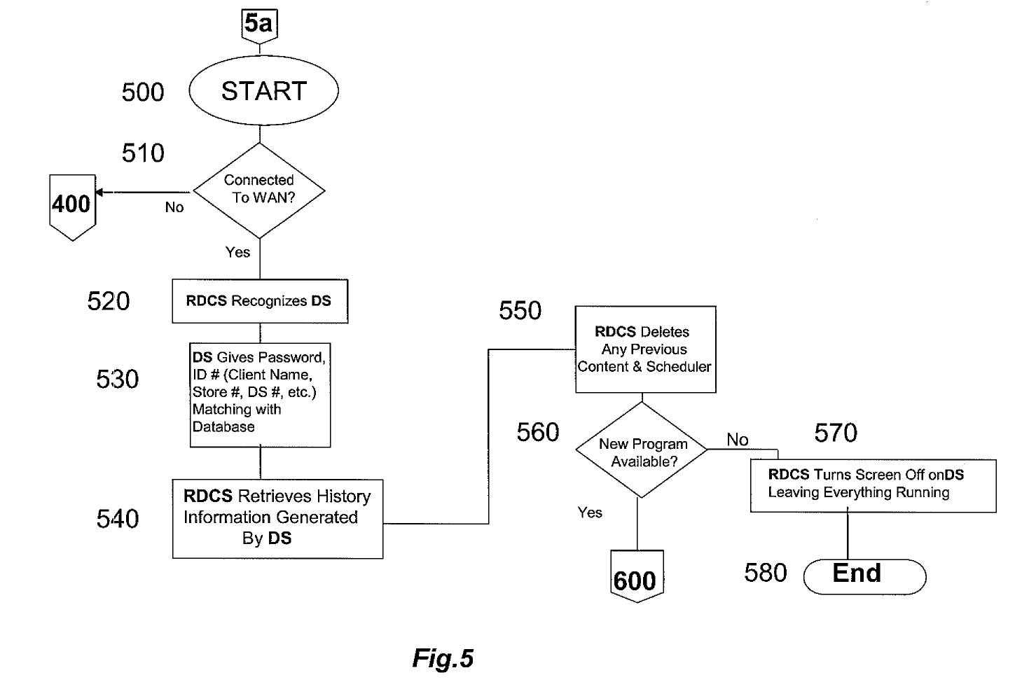

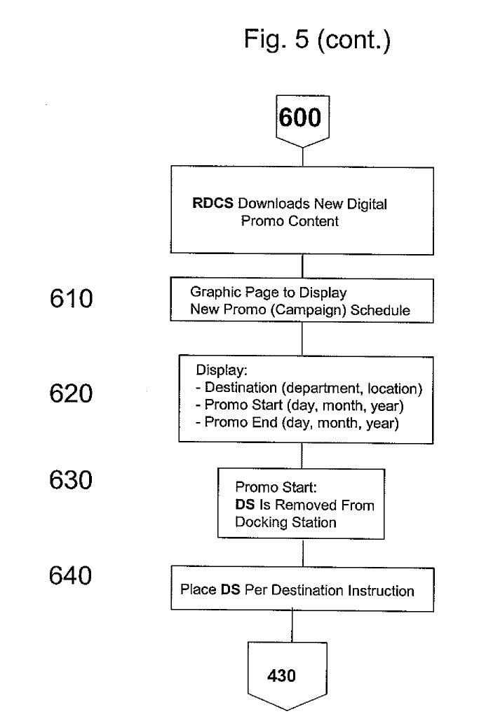

See the flowcharts (FIGS. 4a and 5) for the following description of the operating software, which implements a method of centralized management of digital media content with distributed display of the digital media content, comprising the steps of:

at a first, centralized location a data processing system 10 storing in a database 12: digital media content 18 for a plurality of distributed particular machines 100, and data 17 specifying a specific start date, a specific end date, and identities 16 of the plurality of distributed particular machines;

at a plurality of distributed locations, a plurality of particular machines 100 intermittently connecting to the data processing system 10 and transmitting an identity 16 thereto to retrieve, from the data processing system 10, the data 17, and the digital media content 18; and

each of the particular machines 100 transforming the retrieved digital media content 18 and data 17 into a two-dimensional field 250 on a display 150 representative of the digital media content 18 and the data 17.

The digital sign 100 is powered on at step 400. At 410, a test is made to determine whether the digital sign 100 is connected to the WAN, suitably through the connection 120. If the sign 100 is not connected to the WAN, a schedule program is launched at step 420. The schedule program at step 430 runs a promotional program based on an internal scheduler. As long as the promotional program has not expired, it collects statistical information related to the playback schedule at step 440. At step 440 a test is made to see whether the promotional program has expired. If it has, at step 450 the digital sign either shuts itself off or defaults to a generic program.

If the digital sign is connected to the WAN, at step 500 each unit will automatically connect with the Remote Data Control Services (RDCS) and register itself as ready. The RDCS will recognize the digital sign 100 at step 520. Doing so, RDCS will now know how many and what kind of devices are present in the specific store. From this point on, RDCS will have all the necessary information required to remotely manage one or multiple store chains with any number of store outlets per chain.

Once the RDCS recognizes the digital sign 100, the digital sign 100 at step 530 will give to the RDCS information such as a password and an identification number. The RDCS will then check the password and identification number against a database, and if a match is made, will continue further processing.

At step 540, the RDCS will retrieve from the digital sign 100 historical information. Such historical information may comprise, without limit, any previous content which the digital sign 100 has displayed and a schedule for any new promotional events. After retrieving such historical information, the RDCS at step 550 deletes any previous content and schedule from the digital sign 100.

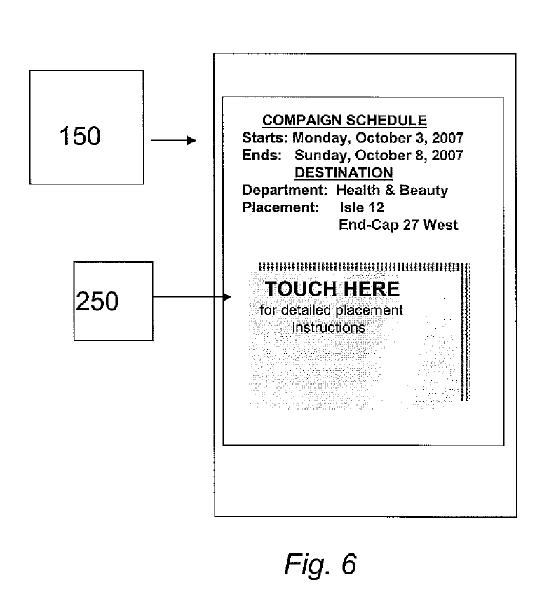

If a new promotional program is available (step 560), at step 600 the RDCS will download new digital promotional content to the digital sign 100. At step 610, the digital sign 100 displays on the display 150 a graphic page with content from the new promotional campaign schedule. Such information may be, without limit, the destination (e.g., the department and location), the start date of the promotional program, and the end date of the promotional program, as illustrated generally at step 620; FIG. 6 illustrates, by example, information that may be displayed on the digital sign display 150 to instruct the operator.

At step 630, the digital sign 100 is removed from the docking station 120. At step 640, the digital sign 100 is placed at the appropriate destination within the retail space.

Once the sign is disconnected from the docking station 120, the RDCS will register the disconnect.

Once the sign is placed at the designated location in the store and turned on, a clock (in the operational software, not specifically shown) will monitor the start and end of the promotional program at step 430. Once the promotional program has expired (step 450), the digital sign 100 may most preferably automatically purge itself of all original promotional event material and revert to a generic message specific to a particular department or location (step 460). The operational software will then wait for the digital sign to be reconnected to the docking station 120. When the digital sign is returned to the docking station 120, the RDCS will at step 570 retrieve operating statistics from the digital sign 100 and turn off the display 150.

As soon as a new promotional program is scheduled, the above operational software is re-executed.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive.

What is claimed:

1. A digital signage system for centralized management of digital media content with distributed display of the digital media content, comprising:
(a) a centralized data processing system further comprising: a database containing digital media content, the digital media content implementing a retail promotion having a specific start date, a specific end date, and identities of a plurality of distributed particular machines implementing the retail promotion; and a first network connection;
(b) a plurality of particular machines implementing the distributed display of the digital media content, each particular machine farther comprising: a central processing unit, a display, and a memory storing the identity of the particular machine; a program executing in the memory; and a second network connection;
(c) wherein each of the plurality of particular machines intermittently connects to the centralized data processing system through the first connection and the second connection, the centralized data processing system receiving the identity of the particular machine and downloading the digital media content to that identified particular machine;
(d) wherein the program executing in the memory of each of the plurality of particular machines transforms the downloaded digital media content into a two-dimensional field on the display representative of the retail promotion.

2. A digital signage system as in claim 1, further comprising at least one docking station, the docking station being removably connectable to at least one of the plurality of particular machines, the centralized data processing system downloading the digital media content to the particular machine through the docking station, the docking station providing power and network connectivity to the particular machine.

3. A digital signage system as in claim 1, wherein each of the plurality of particular machines further comprises a timer implementing the start date and the end date, the program calculating statistics relative to the promotion and purging the memory of data specific to the promotion other than the statistics at expiration of the timer.

4. A digital signage system as in claim 3, wherein the centralized data processing system gathers the statistics from each of the plurality of particular machines when each of the plurality of particular machines reconnects to the centralized data processing system.

5. A digital signage system as in claim 1, wherein each of the plurality of particular machines further comprises a motion detector turning off power to the display when no motion is detected within a specified distance from the particular machine and within a specified time, and turning on power to the display when motion is detected.

6. A method of centralized management of digital media content with distributed display of the digital media content, comprising the steps of:
(a) at a first, centralized location, a data processing system storing in a database: digital media content for a plurality of distributed particular machines, and data specifying a specific start date, a specific end date, and identifies of the plurality of distributed particular machines;
(b) at a plurality of distributed locations, a plurality of particular machines intermittently connecting to the data processing system and transmitting an identity thereto to retrieve, from the data processing system, the specific start date, the specific end date, and the digital media content; and
(c) each of the particular machines transforming the retrieved digital media content and data into a two-dimensional field on a display representative of the digital media content and the data.

7. A method as in claim 6, further comprising a step of each particular machine calculating statistics relative to operation of the particular machine and deleting the data and media content at the specific end date.

8. A method as in claim 7, further comprising a step of each particular machine sensing motion there around and blanking the display when no motion is sensed within a specific distance there around and within a specified time, and a step of re-drawing the display when motion is detected.
